(19) United States
(12) Patent Application Publication
(10) Pub. No.: US 2024/0360764 A1
(43) Pub. Date: Oct. 31, 2024

(54) IMPELLER PRELOADING BANDS

(71) Applicant: Hamilton Sundstrand Corporation, Charlotte, NC (US)

(72) Inventors: Viktor Kilchyk, Lancaster, NY (US); Brent Merritt, Southwick, MA (US)

(21) Appl. No.: 18/671,288

(22) Filed: May 22, 2024

Related U.S. Application Data
(63) Continuation-in-part of application No. 17/962,174, filed on Oct. 7, 2022, now abandoned.

(51) Int. Cl. F01D 5/02; F01D 11/02

(52) U.S. Cl. CPC F01D 5/02; F01D 11/02; F05D 2300/603

(57) ABSTRACT

An impeller includes a hub. The hub has a first end and a second end and includes an impeller disk at the second end of the hub. The impeller disk includes a first annular protrusion extending from the impeller disk. A first pocket is in a radially outer side of the first annular protrusion. The impeller also includes a first preloading band positioned in the first pocket. The first preloading band encircles the radially outer side of the first annular protrusion. The impeller also includes blades connecting to a radially outer surface of the hub.

### CROSS-REFERENCE TO RELATED APPLICATION(S)

This application is a continuation-in-part of U.S. application Ser. No. 17/962,174 filed Oct. 7, 2022, for “IPELLER PRELOADING BANDS” by V. Kilchyk and B. J. Merritt.

### BACKGROUND

This disclosure relates to impellers for rotary machines and, more specifically, preloading bands that place elastic force on impellers.

Rotary machines, like compressors, turbines, and blowers, include impellers which spin at high rates when the rotary machine is in operation. Impellers have a curved shape to help increase or decrease angular velocity as fluid moves through them. Impellers are asymmetrical along an axis of rotation and therefore deform axially when rotating. Axial deformation reduces efficiency of rotary machines with impellers.

Thick and heavy metal walls in impeller hubs are typically used to reduce axial deformations. Metal in a middle of the hub supports a disk at a back of the hub to support a radially outer edge of an impeller and reduce deformation. However, rotary machines utilized in aircraft benefit from reduced weight. Heavy impellers increase the weight of rotary machines and require more containment, which also increases the weight of rotary machines.

### SUMMARY

An impeller includes a hub. The hub has a first end and a second end and includes an impeller disk at the second end of the hub. The impeller disk includes a first annular protrusion extending from the impeller disk. A first pocket is in a radially outer side of the first annular protrusion. The impeller also includes a first preloading band positioned in the first pocket. The first preloading band encircles the radially outer side of the first annular protrusion. The impeller also includes blades connecting to a radially outer surface of the hub.

A rotary machine includes a housing, an impeller, a shroud, and a shaft. The housing includes an inlet, an outlet, and a duct connecting the inlet and the outlet. The impeller is within the duct. The impeller includes a hub, a first preloading band, and blades. The hub includes a first end and a second end. The hub includes an impeller disk at the second end of the hub. The impeller disk has a first annular protrusion extending from the impeller disk and a first pocket in a radially outer side of the first annular protrusion. The first preloading band is positioned in the first pocket and encircling the radially outer side of the first annular protrusion. The blades connected to a radially outer surface of the hub. The shroud is between the impeller and the housing. The shaft attaches to the impeller at the first end of the hub. The impeller rotates with the shaft.

### BRIEF DESCRIPTION OF THE DRAWINGS

FIG. 1 is a cross sectional view of a prior art air cycle machine.

FIG. 2 is a cut away cross-sectional view of a prior art compressor impeller in the air cycle machine of FIG. 1.

FIG. 3 is a cut away cross-sectional view of a rotary machine with an impeller having a first preloading band and a second preloading band.

FIG. 4 is a cut away cross-sectional view of a rotary machine with an impeller having a hollow in a hub of the impeller.

FIGS. 5-8 are schematic cross-sectional views of alternative configurations of an impeller and first preloading band of a rotary machine.

FIG. 9 is a schematic cross-sectional view of one embodiment of a preloading band.

FIG. 10 is a schematic cross-sectional view of another embodiment of a preloading band.

### DETAILED DESCRIPTION

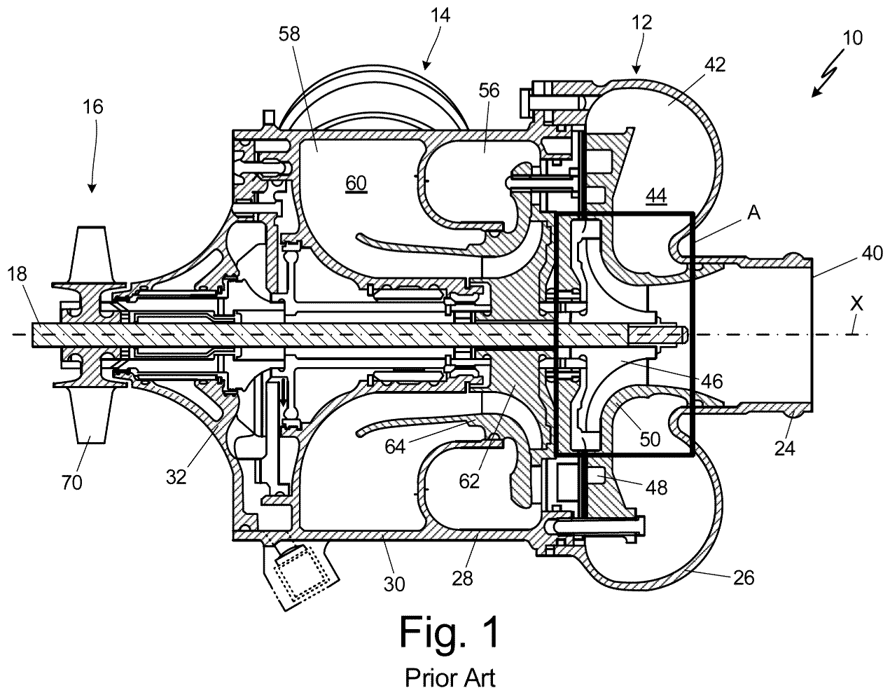

FIG. 1 is a cross-sectional view of prior art air cycle machine 10. Air cycle machine 10 includes compressor section 12, turbine section 14, fan section 16, and shaft 18. Compressor section 12 includes compressor inlet housing 24 and compressor duct housing 26. Turbine section 14 includes turbine inlet housing 28 and turbine duct housing 30. Fan section 16 includes fan housing 32. Compressor section 12 also includes compressor inlet 40, compressor outlet 42, compressor duct 44, compressor impeller 46, diffuser 48, and compressor shroud 50. Turbine section 14 includes turbine inlet 56, turbine outlet 58, turbine duct 60, turbine impeller 62, and turbine shroud 64. Fan section 16 includes blades 70. FIG. 1 also includes axis X and rectangle A.

In air cycle machine 10, compressor section 12, turbine section 14, and fan section 16 are all mounted on shaft 18. Shaft 18 rotates around central axis X. Compressor inlet housing 24 and compressor duct housing 26 are a housing for compressor section 12. Compressor inlet housing 24 and compressor duct housing 26 are an integral piece with compressor inlet housing 24 connected to a first side of compressor duct housing 26. Turbine inlet housing 28 and turbine duct housing 30 are an integral housing for turbine section 14. Turbine inlet housing 28 connects to a second side of compressor duct housing 26. Fan housing 32 connects to turbine duct housing 30 on a side opposite turbine inlet housing 28. Fan housing 32 is a housing for fan section 16.

Compressor section 12 includes compressor inlet 40, compressor outlet 42, compressor duct 44, compressor impeller 46, diffuser 48, and compressor shroud 50. Compressor inlet 40 is an opening in compressor inlet housing 24. Compressor outlet 42 is an opening in compressor duct housing 26. Compressor duct 44 fluidly connects compressor inlet 40 with compressor outlet 42. Compressor impeller 46 is within compressor duct 44 and mechanically connected to shaft 18. Diffuser 48 is within compressor duct 44 and located radially outward from compressor impeller 46. A first portion of compressor shroud 50 connects to a radially inner surface of compressor inlet housing 24. A second portion of compressor shroud 50 connects to diffuser 48. Compressor shroud 50 partially surrounds compressor impeller 46. Rectangle A is positioned around compressor impeller 46.

Turbine section 14 includes turbine inlet 56, turbine outlet 58, turbine duct 60, turbine impeller 62, and turbine shroud 64. Turbine inlet 56 is an opening into turbine inlet housing 28. Turbine outlet 58 is an opening in turbine duct housing 30. Turbine duct 60 fluidly connects turbine inlet 56 with turbine outlet 58. Turbine impeller 62 is within turbine duct 60. Turbine impeller 62 mechanically connects to shaft 18. Turbine shroud 64 connects to turbine inlet housing 28. Turbine shroud 64 is radially outward from and partially surrounds turbine impeller 62. Turbine shroud 64 includes a turbine nozzle towards a downstream portion of turbine shroud 64.

Fan section 16 includes fan blades 70. Fan blade 70 is mounted on shaft 18. Fan blades 70 rotate with shaft 18. Fan section 16 draws in ram air from a ram air scoop or, alternatively, from an associated gas turbine or other aircraft component. Fan section 16 may also be used to draw air through a heat exchanger.

Air is received in air cycle machine 10 at compressor inlet 40. Air sources include ram air, an associated gas turbine engine or another aircraft component. The air passes through compressor section 12 where the air is compressed with compressor impeller 46 and diffuser 48. Compressor outlet 42 discharges the air from compressor section 12. Compressed air can pass through a heat exchanger and be used for other processes on an aircraft. Compressor shroud 50 provides containment in case of catastrophic failure of compressor impeller 46.

Air is routed into turbine inlet 56 from the heat exchanger or other places where compressed air is necessary in an aircraft. The air expands and drives turbine impeller 62 as it passes through turbine section 14. The turbine nozzle on turbine shroud 64 helps decrease the pressure of air moving through turbine shroud 64. Air is discharged out of turbine outlet 58 and can then be routed to other parts of the aircraft, for example, for use as cabin air. Turbine shroud 64 provides containment in case of catastrophic failure of turbine impeller 62.

Compressor shroud 50 and turbine shroud 64 provide containment for compressor impeller 46 and turbine impeller 62, respectively. Containment refers to the ability of a first component to confine a second component upon the second component mechanically failing. Containment is necessary to protect passengers and other aircraft systems from projectile rotary machine components and to comply with aircraft safety regulations. The amount of containment necessary is measured in grams of material. A heavier impeller requires more grams of containment. However, increasing the weight of containment on compressor shroud 50 and turbine shroud 64 make air cycle machine 10 heavier overall and less ideal for use in aircraft.

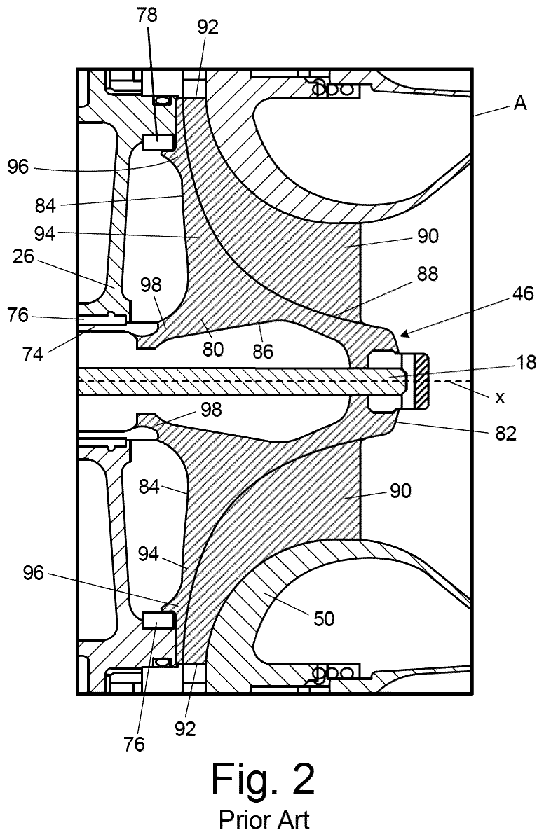

FIG. 2 is a cut away cross-sectional view of prior art compressor impeller 46 in air cycle machine 10 of FIG. 1. FIG. 2 shows compressor impeller 46 and compressor shroud 50 from rectangle A in FIG. 1. FIG. 2 also shows shaft 74, journal bearing 76, and seal 78 in air cycle machine 10. Compressor impeller 46 has hub 80 with first side 82, second side 84, radially inner surface 86, and radially outer surface 88. Compressor impeller 46 also has blades 90 with blade tips 92. Hub 80 has impeller disk 94, first annular protrusion 96, and second annular protrusion 98. FIG. 2 also includes axis X.

Compressor impeller 46 is within compressor duct 44 (shown in FIG. 1) and mechanically connected to shaft 74. Shaft 74 is coaxial with and rotates around axis X. Compressor shroud 50 partially surrounds compressor impeller 46. Tie rod 18 extends on axis X and connects compressor impeller 46, turbine impeller 62 (shown in FIG. 1), and fan blades 70 (shown in FIG. 1). Tie rod 18 functions to axially preload and provide axial clamping force to rotating components of air cycle machine 10. Tie rod 18 ensures compressor impeller 46, turbine impeller 62, and fan blades 70 all rotate together. Journal bearing 76 is disposed radially between shaft 74 and a portion of compressor duct housing 26. Shaft 74 is rotationally coupled to journal bearing 76. Journal bearing 76 is concentrically disposed about axis X and generally functions to support shaft 74 as shaft 74 is rotated. Seal 78 is disposed radially between compressor impeller 46 and a portion of compressor duct housing 26. Seal 78 is configured to provide sealing activity with first annular protrusion 96 of compressor impeller 46 during operation. The sealing geometry of first annular protrusion 96 can be distorted during rotation of compressor impeller 46 due to centrifugal forces acting on centrifugal impeller 46 and thermal expansion of compressor impeller 46.

Compressor impeller 46 has hub 80 with a first side 82 mechanically connected to shaft 74. Second side 84 of hub 80 is axially away from first side 82. Radially inner surface 86 of hub 80 faces shaft 74. Radially outer surface 88 of hub 80 is across from radially inner surface 86 of hub 80 and faces shroud 50. Hub 80 is solid between radially inner surface 86, radially outer surface 88, and second side 84. Radially outer surface 88 is a curved surface that is generally parallel to shaft 74 near first side 82 of hub 80. Radially outer surface 88 is generally perpendicular to shaft 74 near second side 84 of hub 80. Blades 90 are attached to radially outer surface 88 of hub 80. Blade tips 92 are at a downstream portion of compressor impeller 46. Blade tips 92 extend axially away from radially outer surface 88 of hub 80 such that blade tips 92 are generally parallel to shaft 74. Impeller disk 94 extends along second side 84 of hub 80 and supports blade tips 92. Impeller disk 94 is generally perpendicular to shaft 74. First annular protrusion 96 extends axially outward from impeller disk 94 at second side 84 of hub 80. First annular protrusion 96 is near a radially outer portion of impeller disk 94 and is adjacent to seal 78. First annular protrusion 96 rotates relative to seal 78, which is stationary. Second annular protrusion 98 extends axially outward from impeller disk 94 at second side 84 of hub 80. Second annular protrusion 98 is near a radially inner portion of impeller disk 94. Second annular protrusion 98 connects to and rotates with shaft 74.

Hub 80 supports and rotates blades 90 during operation of air cycle machine 10. Impeller disk 94 supports blade tips 92 while compressor impeller 46 spins. Blade tips 92 deflect axially during rotation of compressor impeller 46 due to centrifugal forces and the curved shape of both radially outer surface 88 of hub 80 and blades 90. Impeller disk 94, and in turn blade tips 92, are supported by the solid structure of hub 80 between radially inner surface 86, radially outer surface 88, and impeller disk 94 at second side 84 of hub 80. The solid structure of hub 80 increases the weight of compressor impeller 46, which requires shroud 50 to be thick (and therefore heavy) to provide containment for compressor impeller 46. The necessary containment weight in shroud 50 and the weight of compressor impeller 46 increases the weight of air cycle machine 10.

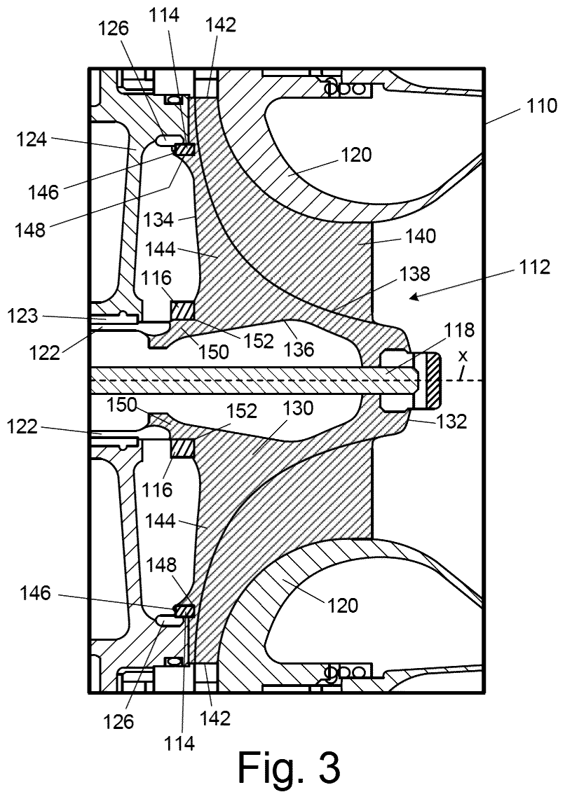

FIG. 3 is a cut away cross-sectional view of rotary machine 110. Rotary machine 110 is an example rotary machine and could be any rotary machine utilizing an impeller including a compressor (for example, compressor section 12 in FIG. 1), a turbine (for example, turbine section 14 in FIG. 1), or a blower. Rotary machine 110 is substantially similar to section A of air cycle machine 10 shown in FIG. 2 with the addition of first preloading band 114 and second preloading band 116 applied to impeller 112. Impeller 112 includes hub 130 with first side 132, second side 134, radially inner surface 136, and radially outer surface 138. Impeller 112 also includes blades 140 with blade tips 142. Hub includes impeller disk 144, first annular protrusion 146 with first pocket 148, and second annular protrusion 150 with second pocket 152.

First preloading band 114 and second preloading band 116 are annular structures configured to restrain axial deflection of blade tips 142 during operation of rotary machine 110 by applying a compressive force against first annular protrusion 146 and second annular protrusion 150, respectively. Addition of first preloading band 114 and second preloading band 116 can enable use of impellers (e.g., impeller 112) and containment and/or support structures (e.g., housing 124) having reduced weight, as discussed further herein. First preloading band 114 can have multiple functions. As discussed further herein, first preloading band 114 can additionally function as a seal or redundant bearing. First preloading band 114 can replace the sealing function of first annular protrusion 96 in air cycle machine 10. First preloading band 114 can be used to avoid seal geometry variation and distortion due to centrifugal forces and thermal expansion.

As illustrated in FIG. 3, rotary machine 110 also includes tie rod 118, shroud 120, shaft 122, journal bearing 123, housing 124, and seal 126. In some embodiments, seal 126 can be eliminated. FIG. 3 also includes axis X.

Impeller 112 is disposed within a duct (for example, compressor duct 44 or turbine duct 60 shown in FIG. 1) and mechanically connected to tie rod 118 and shaft 122. Shaft 122 is coaxial with and rotates around axis X. Shroud 120 partially surrounds impeller 112. Tie rod 118 extends through impeller 112 and functions to axially preload and provide axial clamping force to impeller 112. Housing 124 (for example, compressor duct housing 26 or turbine duct housing 30) partially surrounds and supports impeller 112, shaft 122, and shroud 120. Housing 124 also encloses a duct (for example, compressor duct 44 or turbine duct 60 shown in FIG. 1) that impeller 112 and shroud 120 sit within. Seal 126 is between impeller 112 and housing 124.

Impeller 112 includes hub 130 with first side 132 that connects to tie rod 118. Second side 134 of hub 130 is axially away from first side 132 and connects to shaft 122. Radially inner surface 136 of hub 130 faces tie rod 118. Radially outer surface 138 is across from radially inner surface 136 of hub 130 and faces shroud 120. Hub 130 is solid between radially inner surface 136, radially outer surface 138, and second side 134. Radially outer surface 138 is a curved surface that is generally parallel to tie rod 118 near first side 132 of hub 130 and is generally perpendicular to tie rod 118 near second side 134 of hub 130. Blades 140 are attached to radially outer surface 138 of hub 130. Blade tips 142 extend axially from outer radially surface 138 of hub near second side 134 and are generally parallel to tie rod 118 and shaft 122. Impeller disk 144 extends along second side 134 of hub 130 and supports blade tips 142. Impeller disk 144 is generally perpendicular to tie rod 118 and shaft 122. Impeller disk 144 supports blade tips 142.

First annular protrusion 146 extends axially outward from impeller disk 144 at second side 134 of hub 130. First annular protrusion 146 is near a radially outer portion of impeller disk 144 and adjacent to seal 126. First pocket 148 can be configured to provide axial retention of first preloading band 114 on impeller 112. First pocket 148 can be a divot with a rectangular cross section in a radially outer surface of first annular protrusion 146. First pocket 148 and/or first annular protrusion 146 can have different configurations, as discussed further herein, to provide axial retention of first preloading band 114 on impeller 112. First pocket 148 sits adjacent to impeller disk 144. First preloading band 116 is positioned in first pocket 148 and encircles the radially outer side of first annular protrusion 146.

Second annular protrusion 150 extends axially outward from impeller disk 144 at second side 134 of hub 130. Second annular protrusion 150 is near a radially inner portion of impeller disk 144 and connects to shaft 122. Second pocket 152 is configured to provide axial retention of second preloading band 116 on impeller 112. Second pocket 152 can be a divot with a rectangular cross section in a radially outer side of second annular protrusion 150. Second pocket 152 sits adjacent to impeller disk 144. Second preloading band 116 is positioned in second pocket 152 and encircles the radially outer side of second annular protrusion 150.

Rotary machine 110 works similarly to compressor section 12 or turbine section 14 in air cycle machine 10 (shown in FIG. 1). For example, if rotary machine 110 were a compressor, impeller 112 would be rotated by shaft 122 to increase the angular velocity of air moving through rotary machine 110. In another example, if rotary machine 110 were a turbine, air would move through impeller 112 causing rotation that would be transferred to shaft 122 to power a different impeller or generate electricity. Shroud 120 guides air flow through impeller 112 and provides containment for impeller 112 if there were a mechanical failure in rotary machine 110. Housing 124 defines a duct (for example, compressor duct 44 or turbine duct 60 shown in FIG. 1) for air to move through rotary machine 110 and supports and houses impeller 112, tie rod 118, shroud 120, and shaft 122. Seal 126 is disposed radially outward of first preloading band 114 and is configured to provide a seal with first preloading band 114 upon rotation of impeller 112. In alternative embodiments, seal 126 can be eliminated and first preloading band 114 can be configured to provide non-contact sealing action with housing 124.

Hub 130 supports blades 140 during operation of rotary machine 110. Impeller disk 144 supports blade tips 142 while impeller 112 spins. Blade tips 142 try to deflect axially during rotation of impeller 112 due to centrifugal forces and the curved shape of radially outer surface 138 of hub 130. Impeller disk 144, and in turn blade tips 142, are supported by the solid structure of hub 130 between radially inner surface 136, radially outer surface 138, and second side 134 of hub 130, which helps reduce axial deflections.

First preloading band 114 and second preloading band 116 also help reduce axial deflections in blade tips 142. First preloading band 114 and second preloading band 116 create elastic force against the radially outer side of first annular protrusion 146 and the radially outer side of second annular protrusion 150, respectively. When impeller 112 spins, the elastic force created by first preloading band 114 and second preloading band 116 counteracts the centrifugal force that causes axial deflection at blade tips 142. First pocket 148 and second pocket 152 can hold first preloading band 114 and second preloading band 116 in place, respectively. First pocket 148 and second pocket 152 can be configured to axially retain first preloading band 114 and second preloading band 116 on impeller 112 as described further herein.

First preloading band 114 can have a dual function. In addition to counteracting centrifugal force applied to impeller 112, in some embodiments, first preloading band 114 can be configured to provide a seal between impeller 112 and housing 124. First preloading band 114 can be configured to engage a sealing surface of seal 126 and/or provide non-contact sealing action with seal 126. In some examples, a radially outer surface of first preloading band 114 can include abrasive features configured to cut into an abradable material of seal 126. In some embodiments, the radially outer surface of first preloading band 114 can be configured to provide a labyrinth seal or a dynamic seal as discussed further herein.

In alternative embodiments, first preloading band 114 can be configured to function as a redundant bearing, supporting rotation of impeller 112 against housing 124. For example, first preloading band 114 can be a bushing having an outer radial surface formed of material having a low coefficient of friction to allow for sliding engagement with housing 124 upon rotation of impeller 112.

In one alternative embodiment, impeller 112 can have one preloading band instead of two. For example, impeller 112 can have first preloading band 114 only. In another example, impeller 112 can have second preloading band 116 only. In another alternative embodiment, impeller 112 can have more than two preloading bands. In another embodiment, impeller 112 can have one annular protrusion and one preloading band only. For example, an annular protrusion extending axially outward from second side 134 can be located anywhere radially along impeller disk 144 and can include first pocket 148 and first preloading band 114.

First preloading band 114 and second preloading band 116 can be made from low-weight, high-strength materials (or materials with high strength-to-weight ratios). First preloading band 114 and second preloading band 116 can be formed of materials having a Young's modulus greater than a Young's modulus of the material of impeller 112 to limit deformation of first preloading band 114 and second preloading band 116 in the radial direction relative to impeller 112 due to centrifugal force generated during operation of rotary machine 110. First preloading band 114 and second preloading band 116 can be formed from a plurality of fibers and/or fiber-reinforced material. First preloading band 114 and second preloading band 116 can be formed, for example, from para-aramid fibers (Kevlar®), aramid fibers, carbon fibers (including fire-resistant carbon fibers), nylon fibers, fiberglass (including High Strength High Temperature (HSHT) Fiberglass), metal fibers (including, for example, stainless steel or titanium fibers), and combinations thereof. Combinations of high strength-to-weight ratio materials can be used to create first preloading band 114 and second preloading band 116. These high strength-to-weight ratio materials may also be combined or layered with a composite material like micro carbon fiber filled nylon material (for example, Onyx™ and fire-resistant Onyx™ produced by Markforged), polyetherimide (for example, ULTEM™ 9085 filament produced by Markforged), or other appropriate polymers. Fibers of first and second preloading bands 114 and 116 can extend circumferentially. Fibers can be arranged in a coil or a plurality of coils or joined concentric rings to increase the strength of first preloading band 114 and second preloading band 116 and to improve the ability of first preloading band 114 and second preloading band 116 to counteract centrifugal force applied to impeller 112 during operation. Fibers can be wound around first preloading band 114 and second preloading band 116 in a spiraling manner to avoid cracks in a plane orthogonal to the axis of rotation (axis X). Fibers of varying cross-sectional shapes and sizes can be selected to provide a desired structural arrangement or other mechanical properties, such as a bulk coefficient of thermal expansion (CTE).

First preloading band 114 and second preloading band 116 can be formed of materials selected to provide first preloading band 114 and second preloading band 116 with a bulk CTE that is less than a bulk CTE of impeller 112. The bulk CTE and Young's modulus can be selected to allow first preloading band 114 and second preloading band 116 to counteract centrifugal force applied to impeller 116 during rotation without overstressing impeller 112 or causing mechanical failure of impeller 112, for example, at annular protrusions 146 and 150. In some embodiments, due to preloading, first preloading band 114 and second preloading band 116 can have a CTE equal to a CTE of impeller 112. First preloading band 114 and second preloading band 116 can be composites formed of multiple materials having differing coefficients of thermal expansion any of which may exceed a CTE of impeller 112 while providing a bulk CTE less than the bulk CTE of impeller 112.

Impeller 112 can be formed of a light-weight metal (e.g., aluminum) or composite material, including but not limited to fiber-reinforced polymers. For example, impeller 112 can be formed from aramid fibers (Kevlar®), which have a high tensile strength, disposed in a polymer matrix.

There are multiple means by which first preloading band 114 and second preloading band 116 can be provided on impeller 112. In one embodiment, first preloading band 114 and second preloading band 116 can be additively manufactured and subsequently attached to impeller 112. In another embodiment, first preloading band 114 and second preloading band 116 can be additively manufactured on impeller 112.

First preloading band 114 and second preloading band 116 can be additively formed, for example, by 3D printing. First preloading band 114 and second preloading band 116 can be formed by the simultaneous deposition of fibers and matrix material. For example, fibers can be co-extruded with matrix material to form first preloading band 114 and second preloading band 116 with fibers embedded in the matrix. Fabrication can include selectively printing the fibers to provide a desired fiber arrangement, which may be varied within first preloading band 114 and second preloading band 116 in a radial and/or axial direction. Fibers can be selected and arranged to provide desired material properties. In some embodiments, a dual nozzle can be used to extrude materials of different fiber compositions and/or fiber concentrations. Fibers of varying cross-sectional area and/or shape can also be deposited to provide desired material characteristics or fiber arrangements. First preloading band 114 and second preloading band 116 formed by additive manufacturing can be uninterrupted annular structures. Fibers can be deposited in a circumferential direction as one or more coils or adjoined concentric circles.

The first preloading band 114 and second preloading band 116 formed by additive manufacturing can be added to impeller 112 by placing first preloading band 114 and second preloading band into first pocket 148 and second pocket 152, respectively. For example, rotor 112 can be made through machining, casting, or additive manufacturing using lightweight metal (like aluminum) or a fiber-reinforced plastic. Then impeller 112 can be cooled to allow the metal or composite material to contract, if necessary. This step may not be necessary depending on the amount of elastic force required to keep blade tips 142 from deflecting axially. Next, first preloading band 114 and second preloading band can be fit around first annular protrusion 146 and second annular protrusion 150, respectively. Each of first preloading band 114 and second preloading band 116 can be formed with an inner diameter large enough to accommodate first annular protrusion 146 and second annular protrusion 150, respectively, when impeller 112 is in a cold or contracted state. In some embodiments, first preloading band 112 and second preloading band 114 may be heated to an expanded state for assembly on impeller 112. The inner diameters of first preloading band 114 and second preloading band 116 and/or shape and/or size of first annular protrusion 146 and second annular protrusion 150 can be designed to enable placement of first preloading band 114 and second preloading band 116 on impeller 112 when impeller 112 is in a cold or contracted state. In operation, first preloading band 114 and second preloading band 116 can provide an increasing compressive stress on impeller 112 as impeller 112 forced against first preloading band 114 and second preloading band 116 through centrifugal force and/or thermal expansion.

In another embodiment, first preloading band 114 and second preloading band 116 can be added to impeller 112 by additive manufacturing. For example, impeller 112 can be made through machining, casting, or additive manufacturing using lightweight metal (like aluminum) or a fiber-reinforced plastic. Then, first preloading band 114 and second preloading band 116 can be additively manufactured into first pocket 148 and second pocket 152, respectively. Additive manufacture of first preload band 112 and second preload band 114 can include, for example, winding fiber around each of first annular protrusion 146 and second annular protrusion 150 while simultaneously depositing a polymer matrix to surround adjacent fibers, or co-extruding fiber and matrix material around each of first annular protrusion 146 and second annular protrusion 150. As previously described, fabrication of first preloading band 114 and second preloading band 116 on impeller 112 can include selectively printing fibers to provide a desired fiber arrangement, which may be varied within first preloading band 114 and second preloading band 116 in a radial and/or axial direction. Fibers can be selected and arranged to provide desired material properties. In some embodiments, a dual nozzle can be used to extrude materials of different fiber compositions and/or fiber concentrations. Fibers of varying cross-sectional area and/or shape can also be deposited to provide desired material characteristics or fiber arrangements.

In yet another embodiment, impeller 112 can be additively manufactured with first preloading band 114 and second preloading band 116. For example, impeller 112, including first preloading band 114 and second preloading band 116, can be additively manufactured in a 3D printing process. Impeller 112, first preloading band 114, and second preloading band 116 can be formed from the same materials or different materials with first preloading band 114 and second preloading band 116 formed to have a lower bulk CTE than the impeller 112. For example, impeller 112, first preloading band 114, and second preloading band 116 can be formed from the same aramid (Kevlar®) fibers in a polymer matrix with increased fiber density in first preloading band 114 and second preloading band 116 to reduce the bulk CTE of first preloading band 114 and second preloading band 116 relative to impeller 112.

First preloading band 114 and second preloading band 116 can be formed from different materials and can have differing fiber arrangements and/or fiber cross-sectional shapes and/or sizes to provide desired material properties. First preloading band 114 and second preloading band 116 can have different thicknesses, widths, and shapes. As described further herein, first preloading band 114 and second preloading band 116 can be shaped to fit first and second pocket 148, 152 geometries, respectively.

First preloading band 114 and second preloading band 116 reduce and/or eliminate axial deflections in blade tips 142. Clearance between shroud 120 and impeller 112 can be reduced when axial blade deflections are reduced or eliminated, which increases the performance of rotary machine 110. First preloading band 114 and second preloading band 116 stabilize the geometry of impeller 112 while rotary machine 110 is in operation because first preloading band 114 and second preloading band 116 counteract centrifugal forces working on impeller 112. Having a more stable rotor geometry increases the reliability of impeller 112 and rotary machine 110.

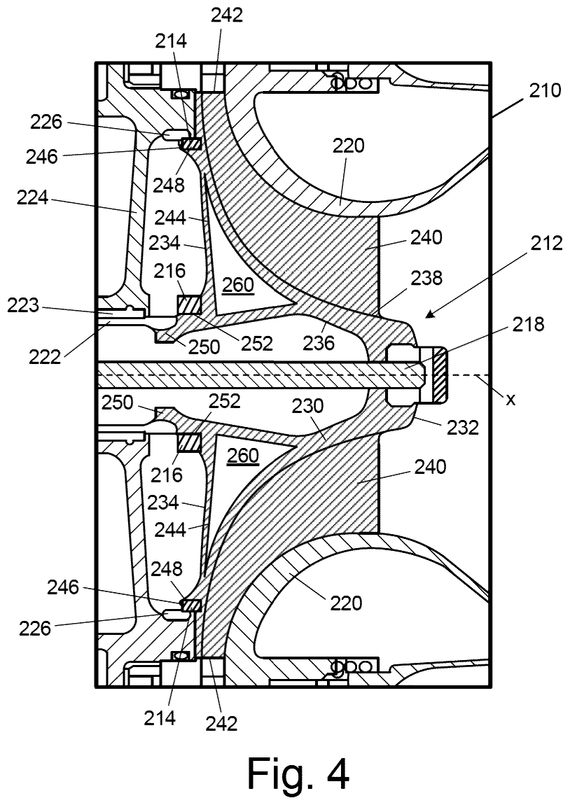

FIG. 4 is a cut away cross-sectional view of rotary machine 210 with impeller 212 having hollow 260 in hub 230. As shown in FIG. 4, rotary machine 210 also includes tie rod 218, shroud 220, shaft 222, journal bearing 223, housing 224, and seal 226. In alternative embodiments, seal 226 can be eliminated as previously discussed with respect to FIG. 3. Impeller 212 includes hub 230 with first side 232, second side 234, radially inner surface 236, and radially outer surface 238. Impeller 212 also includes blades 240 with blade tips 242. Hub includes impeller disk 244, first annular protrusion 246 with first pocket 248, second annular protrusion 250 with second pocket 252, and hollow 260. FIG. 4 also includes axis X.

Rotary machine 210 in FIG. 4 has the same structure and function as rotary machine 210 in FIG. 3 with respect to tie rod 218, tie rod 222, journal bearing 223, housing 224, and seal 226. Impeller 212 in FIG. 4 has the same structure and function as impeller 212 with respect to first preloading band 214; second preloading band 216; hub 230 with first side 232, second side 234, radially inner surface 236, and radially outer surface 238; blades 240 with blade tips 242; impeller disk 244; first annular protrusion 246 with first pocket 248; and second annular protrusion 250 with second pocket 252.

Impeller 212 in FIG. 4 also includes hollow 260 in hub 230. Hollow 260 is a triangular void between radially inner surface 236, radially outer surface 238, and impeller disk 244. Hollow 260 can be shaped differently depending on the weight reduction and structural support needs of hub 230. Impeller 212 can be manufactured with hollow 260 by using reductive manufacturing techniques on a cast or molded impeller 212. Hollow 260 can also be included in hub 230 when additively manufacturing impeller 212.

Hollow 260 in hub 230 reduces the overall weight of impeller 212. Hollow 260 is possible in hub 230 because first preloading band 214 and second preloading band 216 combined with impeller disk 244 give impeller 212 enough structural support to counteract centrifugal forces acting on blade tips 242 when impeller 212 rotates. As discussed in relation to FIG. 2, the metal in hub 230 is typically necessary to structurally support impeller 212 to reduce axial deflections in blade tips 242. However, adding first preloading band 214 on first annular protrusion 246 and second preloading band 216 on second annular protrusion 250 allows for enough elastic force on impeller disk 244 to reduce axial deflections in blade tips 242 that a full-metal hub 230 is not necessary.

Reducing the overall weight of impeller 212 by including hollow 260 in hub 230 reduces the need for containment around impeller 212. As such, shroud 220 in FIG. 4 is shown as thinner as compared to shroud 220 in FIG. 3. Shroud 220 is typically necessary for containing broken pieces of impeller 212 from flying out of rotary machine 210. However, the amount of containment necessary depends on the weight of the piece being contained. Impeller 212 in FIG. 4 has hollow 260 and is lighter than impeller 212 in FIG. 3, so shroud 220 in FIG. 4 is thinner than shroud 220 in FIG. 3. Hollow 260 makes impeller 212 lighter and allows shroud 220 to be lighter, reducing the overall weight of rotary machine 210 in FIG. 4.

Rotary machine 210 has many of the same benefits as rotary machine 210 discussed in relation to FIG. 3. For example, first preloading band 214 and second preloading band 216 reduce and/or eliminate axial deflections in blade tips 242. Further, clearance between shroud 220 and impeller 212 can be reduced when the axial deflections are eliminated or reduced, which increases the performance of rotary machine 210. First preloading band 214 and second preloading band 216 stabilize the geometry of impeller 212 while rotary machine 210 is in operation because first preloading band 214 and second preloading band 216 counteract centrifugal forces working on impeller 212. Having a more stable rotor geometry increases the reliability of impeller 212 and rotary machine 210.

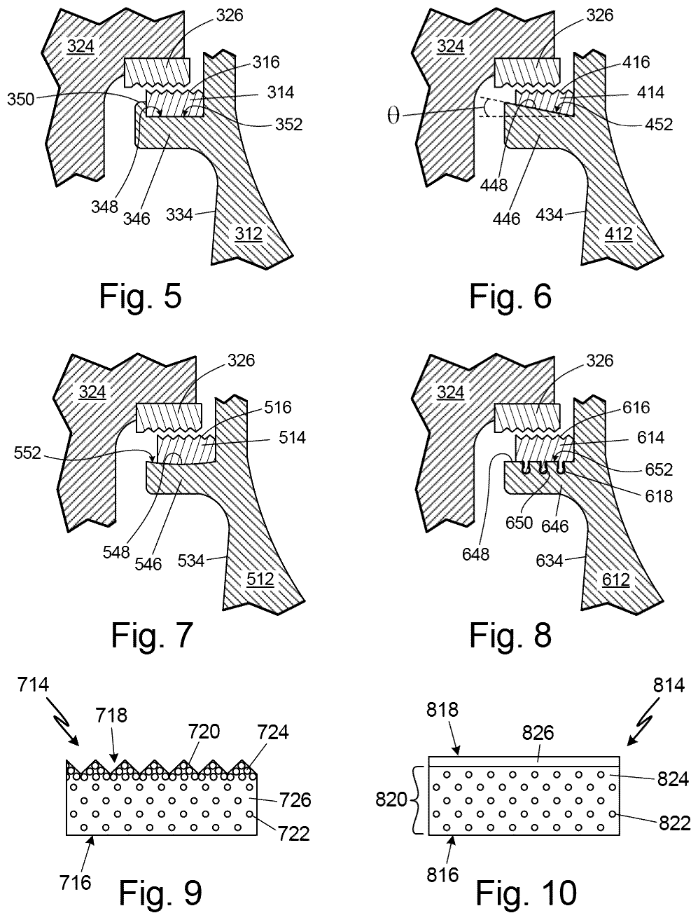

FIGS. 5-8 are schematic cross-sectional views of alternative configurations of an impeller and first preloading band of a rotary machine. Each of FIGS. 5-8 shows housing 324 and seal 326, which are consistent with housings 124 and 224 and seals 126 and 226 of rotary machines 110 of FIG. 3 and 210 of FIG. 4, respectively. FIG. 5 shows impeller 312, having first annular protrusion 346 with first pocket 348, annular flange 350, and base surface 352, and first preloading band 314 having sealing teeth 316. FIG. 6 shows impeller 412, having first annular protrusion 446 with first pocket 448 and base surface 452, and first preloading band 414 having sealing teeth 416. FIG. 7 shows impeller 512, having first annular protrusion 546 with first pocket 548 and base surface 552, and first preloading band 514 having sealing teeth 516. FIG. 8 shows impeller 612, having first annular protrusion 646 with first pocket 648, slots 650, and base surface 652, and first preloading band 614 having sealing teeth 616 and anchors 618.

Impeller 312 can be substantially the same as impeller 112 or 212 of FIGS. 3 and 4. Impellers 412, 512, and 612 can be substantially similar to impellers 112 and 212 of FIGS. 3 and 4 with modifications to first annular protrusions 146 and 246 and first pockets 148 and 248. In all embodiments, first pockets 346, 446, 546, and 646 extend axially outward from a second side 334, 434, 534, 634 of the respective impeller 312, 412, 512, 612 as described with respect to first annular protrusions 146 and 246 of FIGS. 3 and 4, and first preloading band 314, 414, 514, 614 is disposed in a corresponding pocket 348, 448, 548, 648. First preloading bands 314, 414, 514, and 614 are configured to have a dual function. First preloading bands 314, 414, 514, and 614 counteract centrifugal force applied to the respective impeller 312, 412, 512, and 612 and provide sealing activity with seal 326 or, alternatively, housing 324. Seal 326 is configured to provide a seal with first preloading band 314, 414, 514, 614. Seal 326 can be eliminated in any of the disclosed embodiments and preloading bands 314, 414, 514, and 614 can provide sealing action with housing 324 with rotation of impellers 312, 412, 512, and 612, respectively.

FIG. 5 shows first pocket 348 formed in a radially outer surface of first annular protrusion 346. First pocket 348 is an annular slot cut into the radially outer surface of first annular protrusion 346 and extending the full circumference of first annular protrusion 346. First pocket 348 can have a substantially rectangular cross-section defined on three sides by second side 334 of impeller 312 at one axial end, annular flange 350 at an opposite axial end, and base surface 352 extending therebetween. Annular flange 350 projects radially outward from first annular protrusion 346 and is configured to axially restrain first preloading band 314 on impeller 312. A height of annular flange 350 relative to base surface 352 can be selected to provide axial retention of first preloading band 314 during operation of the rotary machine (i.e., prevent first preloading band 314 from slipping off the axially outermost end of first annular protrusion 346) and to provide ease of assembly for embodiments in which first preloading band 314 is positioned on impeller 312 following manufacture of first preloading band 314. Base surface 352 can extend parallel to an axis of rotation of impeller 312 (e.g., axis X of rotary machine 110 or 210).

First preloading band 314 can be formed of a fiber reinforced composite material as previously described and configured to provide desired material properties (i.e., bulk CTE, tensile strength, strength-to-weight ratio, etc.). Fibers can be arranged in one or more coils or adjoined concentric circles. First preloading band 314 can have a plurality of sealing teeth 316 configured to provide a labyrinth seal with seal 326 or, alternatively, housing 324. As described further herein, each sealing tooth 316 can be formed from one or more fibers. In some embodiments, seal 326 can be formed of an abradable material or have an abradable coating and sealing teeth 316 can be formed of an abrasive fiber material capable of cutting into the surface of seal 326 to form rub-grooves, thereby allowing for some radial expansion without damaging sealing teeth 316.

FIG. 6 shows first pocket 448 formed in a radially outer surface of first annular protrusion 446. First pocket 448 is an annular slot cut into the radially outer surface of first annular protrusion 446 and extending the full circumference of first annular protrusion 446. First pocket 448 is defined by second side 434 of impeller 412 and base surface 452. Base surface 452 slants radially inward from an axially outermost end of first annular protrusion 446 to second side 434 and is configured to axially restrain first preloading band 414 on impeller 412. Base surface 452 is angled with respect to an axis of rotation of impeller 412 (e.g., axis X of rotary machine 110 or 210) by angle θ. Angle θ can be selected to provide axial retention of first preloading band 414 during operation of the rotary machine (i.e., prevent first preloading band 414 from slipping off the axially outermost end of first annular protrusion 446) and to provide ease of assembly for embodiments in which first preloading band 414 is positioned on impeller 412 following manufacture of first preloading band 414.

First preloading band 414 can be substantially similar to first preloading band 314 of FIG. 5 with the exception that first preloading band 414 has an increased thickness near second end 434, such that the radially outer surface of first preloading band 414 extends parallel to a radially inner surface of seal 326 or housing 324 in the absence of seal 326. First preloading band 414 can be formed of a fiber reinforced composite material as previously described and configured to provide desired material properties. First preloading band 414 can have a plurality of sealing teeth 416 configured to provide a labyrinth seal with seal 326 or, alternatively, housing 324, as previously described and discussed further herein.

FIG. 7 shows first pocket 548 formed in a radially outer surface of first annular protrusion 546. First pocket 548 is an annular slot cut into the radially outer surface of first annular protrusion 546 and extending the full circumference of first annular protrusion 546. First pocket 548 is defined by second side 534 of impeller 512 and base surface 552. Base surface 552 has a concave shape, curving radially inward from each of an axially outermost end of first annular protrusion 546 and second side 534. The shape of base surface 552 is configured to axially restrain first preloading band 514 on impeller 512. The concavity of base surface 552 can be selected to provide axial retention of first preloading band 514 during operation of the rotary machine (i.e., prevent first preloading band 514 from slipping off the axially outermost end of first annular protrusion 546) and to provide ease of assembly for embodiments in which first preloading band 514 is positioned on impeller 512 following manufacture of first preloading band 514.

First preloading band 514 can be substantially similar to first preloading band 314 of FIG. 5 with the exception that first preloading band 514 has an increased thickness near a center region disposed between the axially outermost end of first annular protrusion 546 and second end 534, such that the radially outer surface of first preloading band 514 extends parallel to a radially inner surface of seal 326 or housing 324 in the absence of seal 326. First preloading band 514 can be formed of a fiber reinforced composite material as previously described and configured to provide desired material properties. First preloading band 514 can have a plurality of sealing teeth 516 configured to provide a labyrinth seal with seal 326 or, alternatively, housing 324, as previously described and discussed further herein.

FIG. 8 shows first pocket 648 formed in a radially outer surface of first annular protrusion 646. First pocket 648 is an annular slot cut into the radially outer surface of first annular protrusion 646 and extending the full circumference of first annular protrusion 646. First pocket 648 is defined by second side 634 of impeller 612 and base surface 652. Base surface 652 can extend parallel to an axis of rotation of impeller 312 (e.g., axis X of rotary machine 110 or 210). Base surface 652 includes slots 650 or grooves. Slots 650 extend circumferentially and are configured to receive and axially restrain first preloading band 614 on impeller 612. Slots 650 can be formed by a series of separate rings or a coil. The number, shape, and size of slots 650 can be selected to provide axial retention of first preloading band 614 during operation of the rotary machine (i.e., prevent first preloading band 614 from slipping off the axially outermost end of first annular protrusion 646) and to provide ease of assembly for embodiments in which first preloading band 614 is positioned on impeller 612 following manufacture of first preloading band 614.

First preloading band 614 can be substantially similar to first preloading band 614 of FIG. 5 with the exception that first preloading band 614 includes anchors 618 configured to be received in corresponding slots 650. First preloading band 614 can be formed of a fiber reinforced composite material as previously described and configured to provide desired material properties. Anchors 618 can have a shape corresponding to a shape of slots 650. Anchors 618 can be formed from one or more fibers disposed in a matrix material. In some embodiments, first preloading band 614 can be additively manufactured on impeller 612 and fibers can be wound around first annular protrusion 646 in slots 650. In some embodiments, anchors 618 can be a series of axially spaced rings configured to be received in a series of corresponding axially spaced slots 650. In an alternative embodiment, anchors 618 can be formed from a coil wound along an inner diameter of first preloading band 614 and configured to be received in a corresponding coiled slot 650 wound around an outer diameter of first annular protrusion 646. Anchors 618 and slots 650 can be provided in any number, shape, and arrangement to axially retain first preloading band 614 on impeller 612. First preloading band 614 can have a plurality of sealing teeth 616 configured to provide a labyrinth seal with seal 326 or, alternatively, housing 324, as previously described and discussed further herein.

FIG. 9 is a schematic cross-sectional view of first preloading band 714. First preloading band 714 has a shape substantially similar to first preloading band 314 of FIG. 5, having inner surface 716, oppositely disposed outer surface 718, and sealing teeth 720 projecting from outer surface 718. First preloading band 714 is a composite material having a plurality of first fibers 722 and second fibers 724 disposed in matrix 726. FIG. 9 illustrates a simplified example of a first preloading band material composition that can be applied to any of the first preloading bands described herein. First fibers 722 and second fibers 724 can be continuous fibers that extend circumferentially around first preloading band 714. First fibers 722 and second fibers 724 can extend a full circumference of first preloading band 714 in a plurality of coils or separated rings. Adjacent first fibers 722 can be axially and radially spaced. First fibers 722 can include a plurality of fiber materials, sizes, and shapes. For example, a subset of first fibers 722 disposed adjacent to inner surface 716 can be formed from a different material, have a different size, or have different spacing than subset of fibers formed adjacent to outer surface 718. The material composition, size, shape, and spacing of first fibers 722 can be selected to finely control the material properties at different locations of first preloading band 714 (e.g., the interface of first preloading band 714 and the impeller) and to control the bulk material properties of first preloading band 714 (e.g., CTE and strength-to-weight ratio).

Second fibers 724 are disposed adjacent outer surface 718 and form sealing teeth 720. Second fibers 724 can be sheathed in or disposed in matrix 726. In some embodiments, second fibers 724 can form the outermost surface of first preloading band 714. Second fibers 724 can be larger in diameter or cross-sectional area than first fibers 722 and/or can be formed of a different material than first fibers 722 to provide increased strength adjacent to outer surface 718 and/or to reduce wear on second fibers 722 with rubbing contact against seal 326 or, alternatively, housing 324 (shown in FIG. 5). For example, in some embodiments, first fibers 722 can be aramid fibers (Kevlar®) and second fibers 722 can be metal (e.g., stainless steel or titanium). Second fibers 722 can have a cross-sectional shape selected to provide a desired geometry of sealing teeth 720 and/or a desired stacking arrangement of adjacent second fibers 722. Second fibers 722 can wrap around first preloading band 714 in a coil or joined concentric rings or can be provided in a plurality of axially spaced and separated concentric rings. The size, shape, arrangement, and material of second fibers 722 can be selected to provide a desired bulk material property (e.g., CTE and strength-to-weight ratio) for first preloading band 714 and a desired local material property (e.g., wear resistance at sealing teeth 720) for first preloading band 714.

Matrix 726 can be a polymer. Matrix 726 can be a thermoplastic. Matrix 726 can include, for example, acrylonitrile butadiene styrene (ABS), polyetherimide (PEI), thermoplastic polyimide, polyether ether ketone (PEEK), polyether ketone (PEKK), polysulfone, polyamide, polyphenylene sulfide, polyester, polyimide, and combinations thereof.

FIG. 10 is a schematic cross-sectional view of first preloading band 814. First preloading band 814 has a dual function. First preloading band 814 is configured to counteract centrifugal force applied to the impeller (i.e., impeller 112 of FIG. 3 or impeller 212 of FIG. 4) to limit blade tip deflection and to function as a redundant or backup bearing for the impeller. First preloading band 814 has inner surface 816 and oppositely disposed outer surface 818. First preloading band 814 is formed of composite substrate 820, having a plurality of first fibers 822 disposed in matrix 824, and layer 826 disposed on composite substrate 826 and forming outer surface 818. FIG. 9 illustrates a simplified example of a first preloading band material composition that can be applied to any of the first preloading bands described herein.

First fibers 822 and matrix 824 can be substantially similar to first fibers 722 and matrix 724 of first preloading band 714 shown in FIG. 9 and described with respect thereto. As previously described, the material composition, size, shape, and spacing of first fibers 822 can be selected to finely control the material properties at different locations of first preloading band 814 (e.g., the interface of first preloading band 714 and the impeller or interface of composite substrate and layer 826) and to control the bulk material properties of first preloading band 814 (e.g., CTE and strength-to-weight ratio).

Layer 826 can be applied to composite substrate 820 in an additive manufacturing process. Layer 826 can be a formed of a self-lubricating material having a low coefficient of friction, including, for example, polytetrafluoroethylene (PTFE) or PTFE with carbon fibers.

### Discussion of Possible Embodiments

The following are non-exclusive descriptions of possible embodiments of the present invention.

In one aspect, an impeller includes a hub. The hub has a first end and a second end and includes an impeller disk at the second end of the hub. The impeller disk includes a first annular protrusion extending from the impeller disk. A first pocket is in a radially outer side of the first annular protrusion. The impeller also includes a first preloading band positioned in the first pocket. The first preloading band encircles the radially outer side of the first annular protrusion. The impeller also includes blades connecting to a radially outer surface of the hub.

The impeller of the preceding paragraph can optionally include, additionally and/or alternatively, any one or more of the following features, configurations and/or additional components:

In a further embodiment of the foregoing impeller, the first annular protrusion can be near a radially outer portion of the impeller disk.

In a further embodiment of any of the foregoing impellers, the first annular protrusion can be near a radially inner portion of the impeller disk.

In a further embodiment of any of the foregoing impellers, the first preloading band can be made from a material chosen from the group consisting of para-aramid fibers, aramid fibers, carbon fibers, nylon fibers, fiberglass, micro carbon fiber filled nylon material, polyetherimide, and combinations thereof.

In a further embodiment of any of the foregoing impellers, the hub can be hollow between the impeller disk, the radially outer surface of the hub, and a radially inner surface of the hub.

A further embodiment of any of the foregoing impellers can further include a second annular protrusion extending from the impeller disk and a second pocket in the radially outer side of the second annular protrusion. The first annular protrusion can be near a radially outer portion of the impeller disk. The second annular protrusion can be near a radially inner portion of the impeller disk.

A further embodiment of any of the foregoing impellers can further include a second preloading band positioned in the second pocket and encircling the radially outer side of the second annular protrusion.

In a further embodiment of any of the foregoing impellers, the first preloading band and the second preloading band can be made from a material chosen from the group consisting of para-aramid fibers, aramid fibers, carbon fibers, nylon fibers, fiberglass, micro carbon fiber filled nylon material, polyetherimide, and combinations thereof.

In a further embodiment of any of the foregoing impellers, the first pocket can have a rectangular cross-section and is located adjacent to the impeller disk, and wherein the second pocket has a rectangular cross-section and is located adjacent to the impeller disk.

In a further embodiment of any of the foregoing impellers, the hub can be hollow between the impeller disk, the radially outer surface of the hub, and a radially inner surface of the hub.

In another aspect, a rotary machine includes a housing, an impeller, a shroud, and a shaft. The housing includes an inlet, an outlet, and a duct connecting the inlet and the outlet. The impeller is within the duct. The impeller includes a hub, a first preloading band, and blades. The hub includes a first end and a second end. The hub includes an impeller disk at the second end of the hub. The impeller disk has a first annular protrusion extending from the impeller disk and a first pocket in a radially outer side of the first annular protrusion. The first preloading band is positioned in the first pocket and encircling the radially outer side of the first annular protrusion. The blades connected to a radially outer surface of the hub. The shroud is between the impeller and the housing. The shaft attaches to the impeller at the first end of the hub. The impeller rotates with the shaft.

The rotary machine of the preceding paragraph can optionally include, additionally and/or alternatively, any one or more of the following features, configurations and/or additional components:

In a further embodiment of the foregoing rotary machine, the impeller disk further includes a second annular protrusion extending from the impeller disk and a second pocket in the radially outer side of the second annular protrusion. The first annular protrusion is near a radially outer portion of the impeller disk. The second annular protrusion is near a radially inner portion of the impeller disk.

In a further embodiment of any of the foregoing rotary machines, the impeller can further include a second preloading band positioned in the second pocket and encircling the radially outer side of the second annular protrusion.

In a further embodiment of any of the foregoing rotary machines, wherein the first preloading band and the second preloading band can be made from a material chosen from the group consisting of para-aramid fibers, aramid fibers, carbon fibers, nylon fibers, fiberglass, micro carbon fiber filled nylon material, polyetherimide, and combinations thereof.

In a further embodiment of any of the foregoing rotary machines, the rotary machines can further include a shaft coaxial with the shaft that rotates with the impeller and the shaft and a journal bearing between the impeller and the housing.

In a further embodiment of any of the foregoing rotary machines, the second annular protrusion can be attached to the shaft.

In a further embodiment of any of the foregoing rotary machines, the first pocket can have a rectangular cross-section and is located adjacent to the impeller disk, and wherein the second pocket has a rectangular cross-section and is located adjacent to the impeller disk.

In a further embodiment of any of the foregoing rotary machines, the hub can be hollow between the impeller disk, the radially outer surface of the hub, and a radially inner surface of the hub.

In yet another aspect, an impeller includes a hub with a first end and a second end with an impeller disk at the second end of the hub. The impeller disk includes a first annular protrusion extending from the impeller disk at a location near a radially outer portion of the impeller disk and a second annular protrusion extending from the impeller disk at a location near a radially inner portion of the impeller disk. The impeller further includes blades connected to a radially outer surface of the hub, a first preloading band encircling a radially outer side of the first annular protrusion, and a second preloading band encircling a radially outer side of the second annular protrusion.

The impeller of the preceding paragraph can optionally include, additionally and/or alternatively, any one or more of the following features, configurations and/or additional components:

In a further embodiment of the foregoing impeller, each of the first preloading band and the second preloading band can be formed from a fiber-reinforced composite material configured to counteract a centrifugal force applied to the impeller during operation.

In a further embodiment of any of the foregoing impellers, a bulk coefficient of thermal expansion of each of the first preloading band and second preloading band can be less than a bulk coefficient of thermal expansion of the hub, disk, and blades of the impeller.

In a further embodiment of any of the foregoing impellers, the fiber-reinforced composite material can include a polymer matrix.

In a further embodiment of any of the foregoing impellers, fibers of the fiber-reinforced composite material can be selected from the group consisting of para-aramid fibers, aramid fibers, carbon fibers, nylon fibers, fiberglass, metal, and combinations thereof.

In a further embodiment of any of the foregoing impellers, the hub can be hollow between the impeller disk, the radially outer surface of the hub, and a radially inner surface of the hub.

In a further embodiment of any of the foregoing impellers, the first preloading band can be disposed in a pocket configured to axially retain the first preloading band on the first annular protrusion.

In a further embodiment of any of the foregoing impellers, the first pocket can have a rectangular cross-section defined between the disk and an annular flange disposed at an axially outermost end of the first annular protrusion.

In a further embodiment of any of the foregoing impellers, the pocket can include a plurality of slots open to the radially outer side of the first annular protrusion and wherein the first preloading band comprises a plurality of anchors configured to be received in the plurality of slots.

In a further embodiment of any of the foregoing impellers, the pocket can be defined by a slanted surface of the outer side of the first annular protrusion, the slanted surface extending radially inward from an axially outermost end of the first annular protrusion to the disk.

In a further embodiment of any of the foregoing impellers, the first preloading band can include a plurality of sealing teeth configured to provide a labyrinth seal.

In a further embodiment of any of the foregoing impellers, the plurality of sealing teeth can include a plurality of circumferentially extending fibers.

In a further embodiment of any of the foregoing impellers, the first preloading band can have an outer surface comprising a self-lubricating material.

In yet another aspect, a rotary machine includes a housing having an inlet, an outlet, and a duct connecting the inlet to the outlet. The rotary machine further includes an impeller within the duct in the housing. The impeller includes a hub with a first end and a second end with an impeller disk at the second end of the hub. The impeller disk includes a first annular protrusion extending from the impeller disk at a location near a radially outer portion of the impeller disk and a second annular protrusion extending from the impeller disk at a location near a radially inner portion of the impeller disk. A first preloading band encircles a radially outer side of the first annular protrusion. A second preloading band encircles a radially outer side of the second annular protrusion. Blades are connected to a radially outer surface of the hub. A shroud is disposed between the impeller and the housing, and a shaft is attached to the second annular protrusion of the impeller such that the impeller rotates with the shaft.

The rotary machine of the preceding paragraph can optionally include, additionally and/or alternatively, any one or more of the following features, configurations and/or additional components:

In a further embodiment of the foregoing rotary machine, the first preloading band and the second preloading band can be formed from a fiber-reinforced composite material configured to counteract a centrifugal force applied to the impeller during operation.

In a further embodiment of any of the foregoing rotary machines, the first preloading band can be disposed adjacent to the housing or a seal member provided on the housing and wherein the first preloading band is configured to provide sealing activity with the housing or the seal member.

In a further embodiment of any of the foregoing rotary machines, the first preloading band can be a labyrinth seal.

In a further embodiment of any of the foregoing rotary machines, the first preloading band can have a radially outer surface disposed adjacent to the housing and wherein the radially outer surface comprises a self-lubricating material.

In a further embodiment of any of the foregoing rotary machines, the first preloading band can be disposed in a pocket configured to axially retain the first preloading band on the first annular protrusion. The first pocket can include one of 1) a rectangular cross-section defined between the disk and an annular flange disposed at an axially outermost end of the first annular protrusion, 2) a plurality of slots open to the radially outer side of the first annular protrusion and configured to receive a plurality of anchors projecting radially inward from the first preloading band, and 3) a slanted surface of the outer side of the first annular protrusion, the slanted surface extending radially inward from an axially outermost end of the first annular protrusion to the disk.

In a further embodiment of any of the foregoing rotary machines, the hub can be hollow between the impeller disk, the radially outer surface of the hub, and a radially inner surface of the hub.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. An impeller comprising:
a hub with a first end and a second end, the hub comprising:
an impeller disk at the second end of the hub, the impeller disk comprising:
a first annular protrusion extending from the impeller disk at a location near a radially outer portion of the impeller disk; and
a second annular protrusion extending from the impeller disk at a location near a radially inner portion of the impeller disk; and
blades connected to a radially outer surface of the hub;
a first preloading band encircling a radially outer side of the first annular protrusion; and
a second preloading band encircling a radially outer side of the second annular protrusion.

2. The impeller of claim 1, wherein each of the first preloading band and the second preloading band is formed from a fiber-reinforced composite material configured to counteract a centrifugal force applied to the impeller during operation.

3. The impeller of claim 2, wherein a bulk coefficient of thermal expansion of each of the first preloading band and second preloading band is less than a bulk coefficient of thermal expansion of the hub, disk, and blades of the impeller.

4. The impeller of claim 2, wherein the fiber-reinforced composite material comprises a polymer matrix.

5. The impeller of claim 2, wherein fibers of the fiber-reinforced composite material are selected from the group consisting of para-aramid fibers, aramid fibers, carbon fibers, nylon fibers, fiberglass, metal, and combinations thereof.

6. The impeller of claim 1, wherein the hub is hollow between the impeller disk, the radially outer surface of the hub, and a radially inner surface of the hub.

7. The impeller of claim 1, wherein the first preloading band is disposed in a pocket configured to axially retain the first preloading band on the first annular protrusion.

8. The impeller of claim 7, wherein the first pocket has a rectangular cross-section defined between the disk and an annular flange disposed at an axially outermost end of the first annular protrusion.

9. The impeller of claim 7, wherein the pocket comprises a plurality of slots open to the radially outer side of the first annular protrusion and wherein the first preloading band comprises a plurality of anchors configured to be received in the plurality of slots.

10. The impeller of claim 7, wherein the pocket is defined by a slanted surface of the outer side of the first annular protrusion, the slanted surface extending radially inward from an axially outermost end of the first annular protrusion to the disk.

11. The impeller of claim 1, wherein the first preloading band comprises a plurality of sealing teeth configured to provide a labyrinth seal.

12. The impeller of claim 11, wherein the plurality of sealing teeth comprises a plurality of circumferentially extending fibers.

13. The impeller of claim 1, wherein the first preloading band has an outer surface comprising a self-lubricating material.

14. A rotary machine comprising:
a housing comprising:
an inlet;
an outlet; and
a duct connecting the inlet to the outlet;
an impeller within the duct in the housing, the impeller comprising:
a hub with a first end and a second end, the hub comprising:
an impeller disk at the second end of the hub, the impeller disk comprising:
a first annular protrusion extending from the impeller disk at a location near a radially outer portion of the impeller disk; and
a second annular protrusion extending from the impeller disk at a location near a radially inner portion of the impeller disk;
a first preloading band encircling a radially outer side of the first annular protrusion;
a second preloading band encircling a radially outer side of the second annular protrusion; and
blades connected to a radially outer surface of the hub;
a shroud between the impeller and the housing; and
a shaft attached to the second annular protrusion of the impeller, wherein the impeller rotates with the shaft.

15. The rotary machine of claim 14, wherein the first preloading band and the second preloading band are formed from a fiber-reinforced composite material configured to counteract a centrifugal force applied to the impeller during operation.

16. The rotary machine of claim 15, wherein the first preloading band is disposed adjacent to the housing or a seal member provided on the housing and wherein the first preloading band is configured to provide sealing activity with the housing or the seal member.

17. The rotary machine of claim 16, wherein the first preloading band comprises a labyrinth seal.

18. The rotary machine of claim 15, wherein the first preloading band has a radially outer surface disposed adjacent to the housing and wherein the radially outer surface comprises a self-lubricating material.

19. The rotary machine of claim 14, wherein the first preloading band is disposed in a pocket configured to axially retain the first preloading band on the first annular protrusion, wherein the first pocket comprises one of:
a rectangular cross-section defined between the disk and an annular flange disposed at an axially outermost end of the first annular protrusion;
a plurality of slots open to the radially outer side of the first annular protrusion and configured to receive a plurality of anchors projecting radially inward from the first preloading band; and
a slanted surface of the outer side of the first annular protrusion, the slanted surface extending radially inward from an axially outermost end of the first annular protrusion to the disk.

20. The rotary machine of claim 14, wherein the hub is hollow between the impeller disk, the radially outer surface of the hub, and a radially inner surface of the hub.
